(19) United States
(12) Patent Application Publication
(10) Pub. No.: US 2014/0149405 A1
(43) Pub. Date: May 29, 2014

(54) AUTOMATED GENERATION OF NETWORKS BASED ON TEXT ANALYTICS AND SEMANTIC ANALYTICS

(71) Applicant: INTERNATIONAL BUSINESS MACHINES CORPORATION, Armonk, NY (US)

(72) Inventors: Christopher James Dawson, Herndon, VA (US); Ido Guy, Haifa (IL); Rajesh Radhakrishnan, Herndon, VA (US)

(73) Assignee: INTERNATIONAL BUSINESS MACHINES CORPORATION, Armonk, NY (US)

(21) Appl. No.: 13/685,322

(22) Filed: Nov. 26, 2012

(51) Int. Cl. G06F 17/30

(52) U.S. Cl. CPC G06F 17/30286
USPC 707/736

(57) ABSTRACT

A method includes providing data from at least one data source to an analytics engine; outputting data from an identity management system to the analytics engine; outputting data from an enterprise communities database to the analytics engine; causing the analytics engine to issue at least one recommendation based on the data from the at least one data source, the identity management system data and the enterprise communities database data, wherein the determining is executed by at least one processor.

### BACKGROUND

The present invention relates to analytics systems, and more specifically, to using an analytics engine to generate recommendations.

### SUMMARY

According to one aspect of the present invention, a method includes: providing data from at least one data source to an analytics engine; outputting data from an identity management system to the analytics engine; outputting data from an enterprise communities database to the analytics engine;

causing the analytics engine to issue at least one recommendation based on the data from the at least one data source, the identity management system data and the enterprise communities database data, wherein the determining is executed by at least one processor.

According to another aspect of the present invention, a system includes: an analytics engine receiving data from at least one data source; an identity management system providing data to the analytics engine; an enterprise communities database providing data to the analytics engine, wherein the analytics engine issues at least one recommendation based on the data from the at least one data source, the identity management system data and the enterprise communities database data, and wherein the determination is executed by at least one processor.

According to still another aspect of the present invention, a computer program product including a computer readable storage medium having program code stored thereon, wherein the program code when executed on a computer causes the computer to: receive data from at least one data source and provide said data from said at least data source to an analytics engine; receive data from an identity management system and provide said identity management data to said analytics engine; receive data from an enterprise communities database and provide said enterprise communities database data to said analytics engine, wherein said analytics engine issues at least one recommendation based on said data from said at least one data source, said identity management system data and said enterprise communities database data.

### BRIEF DESCRIPTION OF THE SEVERAL VIEWS OF THE DRAWINGS

FIG. 1 depicts a diagram for auto community recommendations according to an embodiment of the present invention.

FIG. 2 illustrates an analytics engine according to one embodiment of the present invention.

FIG. 3 shows a workflow according to an embodiment of the present invention.

FIG. 4 illustrates a hardware configuration according to an embodiment of the present invention.

FIG. 5 shows a storage medium according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

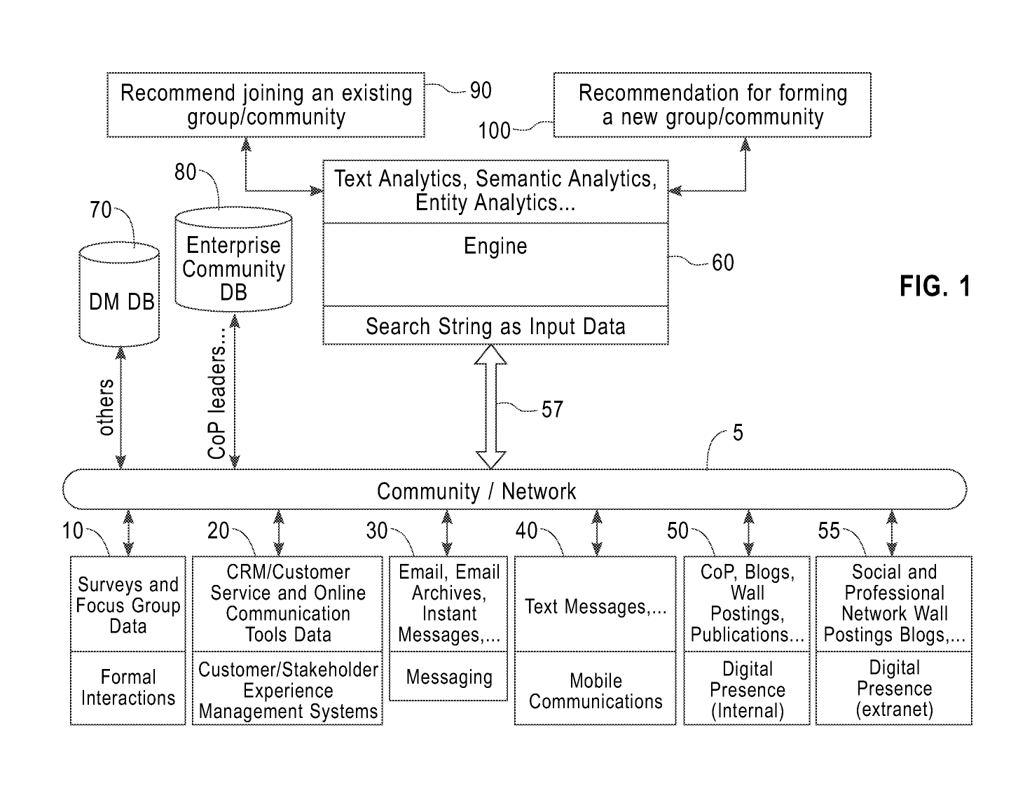

With reference to FIG. 1, within an enterprise intranet and extended enterprise extranet, many users generate all types of structured and unstructured data. The unstructured data may come from formal interactions 10, customer/state holder/experience/interaction systems 20, messaging 30, mobile device communications 40 or a digital presence 50. These are only a few examples of unstructured data generated by users. Formal interactions 10 may also include data collected from an off line survey, an online survey, focus groups or other from text data from other collection mechanisms 13. Customer/state holder/experience/interaction systems 20 may include unstructured data collected from telephone conversations, Instant messaging (IM) chats, online conversations or other communications. Messaging data 30 may include unstructured data from an email directory, email, email traces, email archive or other messaging systems. Unstructured data from mobile devices and communications 40 may include data from mobile email, text message history, current location information, mobile email archive or mobile device directory. It should be noted that the unstructured data from location information may be generated either from a mobile device or from a service providing the location information. More unstructured data may from a digital presence (internal) 50 being generated by blogs and posts, information from web pages or from text data from within the enterprise. Finally, more unstructured data may still come from a digital presence (extranet) 55. The digital presence (extranet) 55 includes social and professional network wall postings, blogs, etc. The digital presence (extranet) 55 also includes extended enterprise systems shared with partners, suppliers, and external communities. An example of such an extranet could be Content Management Systems shared and maintained by partners.

All of the structured and unstructured data generated above is provided as an input to analytics engine 60 via community network 5. The analytics engine 60 in the context of this invention further includes a set of sub analytics modules to convert data (structured and unstructured) into meaningful information which supports communities/network related recommendations and decisions. Each sub-analytics module will have a set code related to an embodiment of the present invention. The analytics engine 60 also decides which analytics module that could be utilized based on the source and type of data. An example of the data may include email and typed messages, unstructured data, in which case the analytics engine 60 may use a text analytics module. Another example of the type of data may include external publication and type, unstructured data, in which case the analytics engine 60 may use both text and semantic analytics modules.

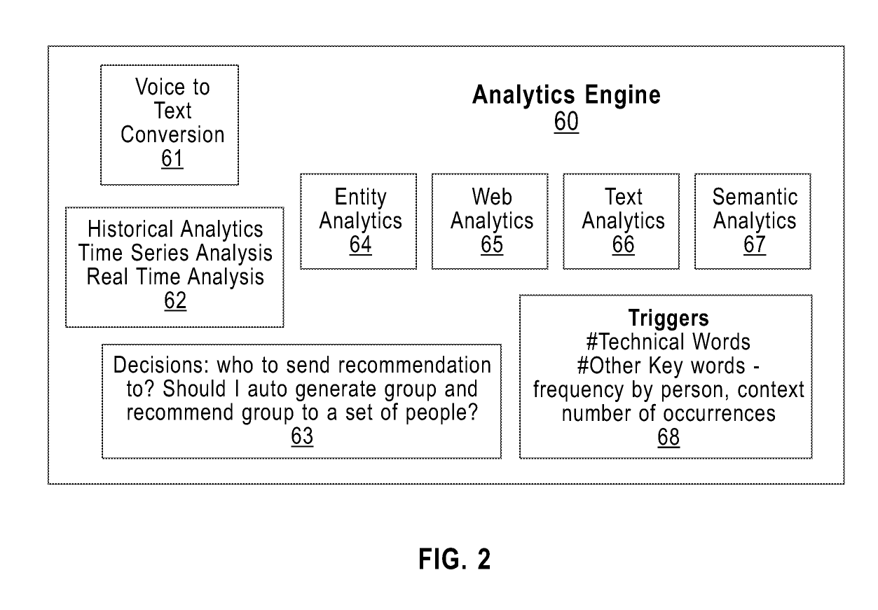

Referring to FIG. 2, an analytics engine 60 converts part of the unstructured data by using a voice to text conversion module 61. The unstructured data is further analyzed within the analytics engine 60 by an analysis tool 62, which sorts the data into historical, time series and real time sequences. The analytics engine 60 uses triggers 68 as identified in the unstructured data. These triggers 68 helps the analytics engine 60 conduct sub analytics on the unstructured data. Before describing the sub analytics modules, the analytics engine 60 further receives input from an identity management system 70 and an enterprise community database 80 via the community network 5. The enterprise community database 80 is a database/data repository that has meta data about the myriad communities within the enterprise and the extended enterprise. The meta data may include community name, date formed, community organizers, URL and tools used, member information, and membership criteria among others. The meta data could also cover the hierarchy relationship between communities—example: IT Service Management (ITSM) community as the parent community to Configuration Management System (CMS) community, which in turn is the parent to the Federated Configuration Management Data Base (CMDB) group. As the unstructured data is generated from the users, it also includes identity information about the users. This identity user information is compared with the identity management database 70 using an entity analytics module 64. The entity analytics module 64 establishes the identity of an individual (entity) who is associated with or authored an internal (to the enterprise) or external blog, publication, write up, review, comment, among others. Example: if John Deer has published a paper in the Health Care IT journal and there are six John Deer within the enterprise—entity analytics will help with detecting the right John Deer.

The entity analytics module 64 also identifies individuals who are network, group or community of practice leaders of related fields when a recommendation for forming a new group is being made. It may be necessary impose security rules to restrict access to certain groups that analytics engine 60 may recommend. The entity analytics module 64 factors in these security aspects (access control, copyrights, IP protections, digital rights, among others) while recommending specific entities (individuals or smaller groups) to join an existing or newly formed groups and get access to the tools and information shared by the group.

The analytics engine 60 further includes a web analytics module 65, a text analytics module 66 and a semantic analytics module 67. The web analytics module measures, collects, conducts analyses and reports on the internet data for purposes of understanding and optimizing web usage. For the purpose of this invention, web analytics is applied to understand end users web usage patterns (including web sites visited, web sites and web content commented on). These usage patterns aid in determining auto-recommendations to join or form specialized or ad hoc groups or communities. The text analytics module 66 deciphers key messages and underlying themes in blogs, publications, write-ups, comments, and other forms of communications. The semantic analytics module 67 identifies potential new names for new groups, which could be formed—based on the underlying themes and synonyms for the key theme. The semantic analytics module 67 further develops automated abstracts that define the new community or group that is being recommended to be formed or automatically formed.

As a result of the analytics engine 60 reviewing all of the structured and unstructured data, the analytics engine 60 issues two possible recommendations. The first possible recommendation is to join a specific group 90. The join recommendation 90 may include sending an email to specific users that initially generated the unstructured data of interest. Other possible ways that users can receive the join a specific group recommendation 90 may include issuing an IM to the user, provide an email notification to the end user's manager or creating a voice mail for the user. The other possible recommendation is to form a new group 100. Users are notified with a suggestion to form a new group. This notification to users may be by email, issuing an IM to the user or by issuing a link to a group formation tool. The recommendation for forming a new group 100 can also provide recommendations for specific entities (individuals, other groups and group members) to learn about the newly formed group and its mission.

The analytics engine 60 answers the following questions:

Is the topic or area of focus in the given text (text file) part of the subject area covered by any of the current communities?
If yes,
1) Would individual A associated with document or file XZ be interested in joining community C1, C2, C3 . . . Cn—that cover the subject area? (then recommend appropriate community/network)
if no,
2) Do we have enough reasons to form a small community that focus on the given topic/specialized subject area? If yes, then recommend formation of a group that focus on the given topic or specialized area.

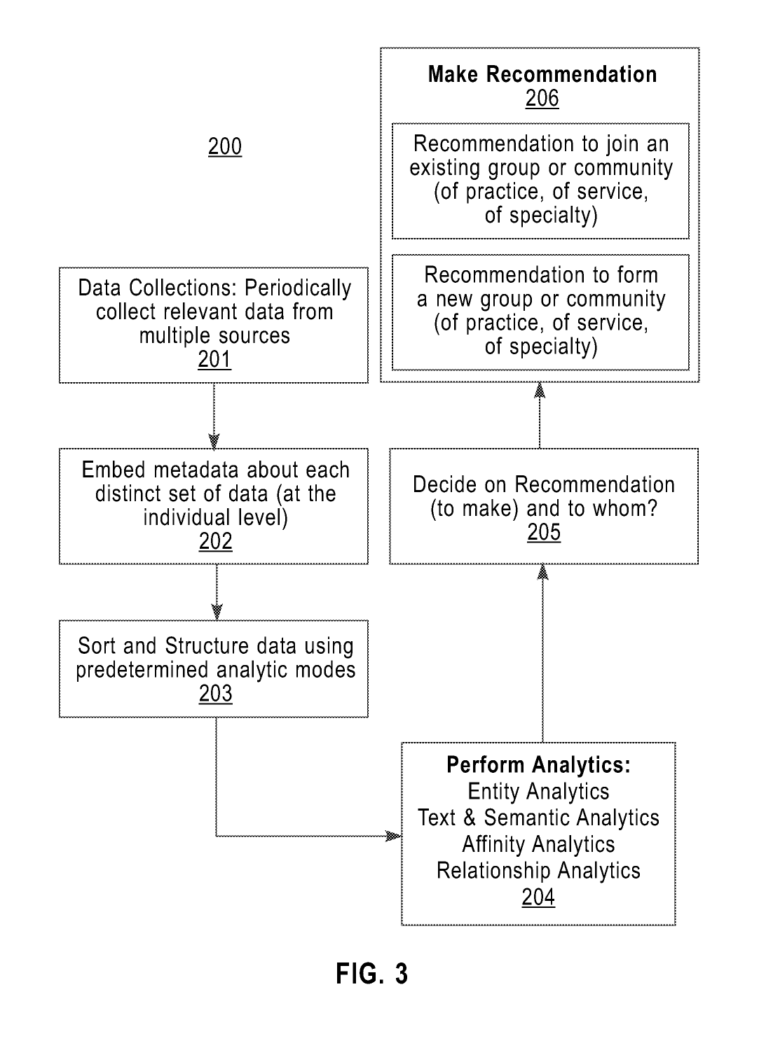

Referring to FIG. 3, a method according to an embodiment of the invention is a flow chart that shows the periodical collection of structured and unstructured data 201 from a plurality of data sources (see FIG. 1) in an enterprise intranet and extended enterprise extranet. The method embeds meta-data 202 about each distinct data/file (data sources, time generated, owner, . . . ) The unstructured data is sorted and structured using a predetermined set of analytic methods 203. Sorting and structuring of the data is determined by the quality of the data, the priority of the data and the relevance and maturity of content. Other additional analytics may be utilized as part of the sorting and structuring of the data. Once the data is sorted and structured, analytics 204 are conducted using text and semantic analytics, entity analytics, affinity analytics and relationship analytics. With regards to affinity and relationship analytics, members belonging to affinity groups are associated with each other and tend to perform activities concurrently and have a relationship with each other. In another embodiment of the invention, web analytic techniques may be conducted as part of the overall analytics 204. The embodiment of the invention uses semantic analytics to arrive at key messages/statements associated with the text data. A further embodiment uses semantic analytics to check if the key messages/statements relate to one or more community groups (groups agenda—common interest).

An embodiment of the present invention furthers deciphers potential interest areas that currently do not have a community/group/network in the enterprise (based on matching the text and semantics to the metadata about current set of communities/groups/networks). The invention also checks the membership (to communities/groups/networks) of each user associated with a topic/interest area from the user ID tagged to text/unstructured data files. This may be done by using a social network and discovery tool.

A decision 205 is made on the type recommendation, a recommendation is issued 206 based the analyzed data—either join recommendation for one or more networks/groups that handles the topic/interest area to which the user does not have membership with, or suggest the formation of a network/group to the user. The decision process will be further described with reference to the examples below.

A preferred embodiment of the invention may be used in Social/Professional networking and related tools such as IBM connections for communities, crowd-sourcing tools, among others are being used to form such network as:

Professional Networks (people belonging to the same profession)
Process Networks (people working on the same business functional process or IT process)
Service Networks (people working on the same service).

Examples of use may be:

Use Case Scenario A: Four researchers R-A, R-B, R-C and R-D at an IT company publish a paper on “High Availability Service Management or HASM” via an external journal and via the enterprise content/knowledge management system. The analytics engine 60 determines that the content of the paper relates to four subjects:

### High Availability

### Resiliency

### Systems Management

### Service Management

This breakdown to a set of interest areas may be around key words (triggers), meta data or other known art mechanism to classify unstructured data. Also, the analytic engine 60 includes a list of current interest areas. In this case, there are already four interest areas—one for each subject area within the enterprise. Author R-A is a member of all four communities. However, authors R-B, R-C and R-D are NOT. After further analysis (additional content associated with authors R-B, R-C and RD), the analytics engine 60 determines that R-B, R-C and R-D may very well be interested on the communities and community activities that they are NOT currently member of. The analytics engine 60 then sends a targeted request (perhaps using email 91) recommending one or more communities that R-B, R-C and R-D may wish to join.

Use Case Scenario B: Two separate groups of employees in a global IT company are working on similar research area “metrics and analytics for or Storage Area Networks (SAN)” and documenting their work in their local content repositories. The analytics engine 60 deciphers the link between the work being done by these separate groups. Also, the analytics engine determines that there is no dedicated community or network within the enterprise that focus on this topic and based on the strength of these two separate groups and the increase trend in terms of volume of activity and number of people involved, recommends the formation of a group 100 which focuses on “Analytics for SAN” to the two leaders of the two groups.

The recommendation to form a new group 100 further includes a decision tree conducting post data analysis. The post data analysis includes:

Decision 1: Is there an underlying theme with this unstructured data set that warrants a dedicated community? This determination could be based on how many times this theme appears for large number of different data sets, how many people are involved with the source data, or how frequently the people involved communicate with each other.
Decision 2: If warranted, what would be the relationship of this new community group to existing communities groups?
A) is it unrelated and independent,
B) is it related but still independent,
C) is it related and dependent?
If C is true, send recommendation to the primary parent community lead organizer.
If B is true, send recommendation to generic community organizers and send the relationship (to existing communities info)
If A is true just send recommendation to the generic community organizers
Decision 3: If new community group is formed, who should be invited to become charter members of the new community?

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

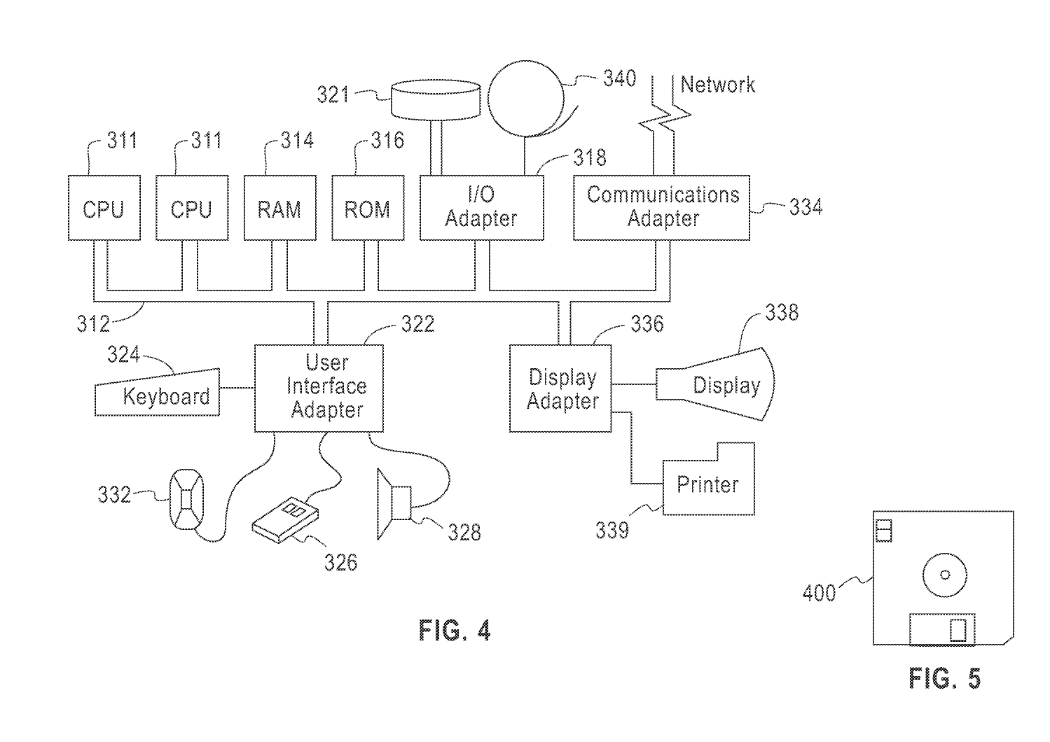

Referring now to FIG. 4, this schematic drawing illustrates a hardware configuration of an information handling/computer system in accordance with the embodiments of the invention. The system includes at least one processor or central processing unit (CPU) 311. The CPUs 311 are interconnected via system bus 312 to various devices such as a random access memory (RAM) 314, read-only memory (ROM) 316, and an input/output (I/O) adapter 318. The I/O adapter 318 may connect to peripheral devices, such as disk units 311 and tape drives 313, or other program storage devices that are readable by the system. The system may read the inventive instructions on the program storage devices and follow these instructions to execute the methodology of the embodiments of the invention. The system further includes a user interface adapter 319 that connects a keyboard 313, mouse 317, speaker 324, microphone 322, and/or other user interface devices such as a touch screen device (not shown) to the bus 312 to gather user input. Additionally, a communication adapter 320 connects the bus 312 to a data processing network 325, and a display adapter 321 connects the bus 312 to a display device 323, which may be embodied as an output device such as a monitor, printer, or transmitter, for example.

Referring to FIG. 5, is noted that the present invention may be embodied as software for storage on a storage device 400 and implemented by the computer system shown in FIG. 4 or by at least one processor over a network of computers.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
the computer providing data from at least one data source to an analytics engine;
the computer outputting data from an identity management system to said analytics engine;
the computer outputting data from an enterprise communities database to said analytics engine; and
the computer causing said analytics engine to issue at least one recommendation based on said data from said at least one data source, said identity management system data and said enterprise communities database data.

2. The method according to claim 1, wherein said at least one data source is unstructured data from an enterprise intranet.

3. The method according to claim 1, wherein said at least one data source is unstructured data from an extended enterprise extranet.

4. The method according to claim 1, wherein said at least one data source is unstructured data that is time generated.

5. The method according to claim 1, wherein said at least one data source is embedded meta-data from distinct data.

6. The method according to claim 1, further comprising causing said analytics engine to process said data from said at least one data source using text analytics.

7. The method according to claim 1, further comprising causing said analytics engine to process said data from said at least one data source using web analytics.

8. The method according to claim 1, further comprising causing said analytics engine to process said data from said identity management communities database using identity analytics.

9. The method according to claim 1, further comprising causing said analytics engine to process said data from said enterprise communities database using identity analytics.

10. The method according to claim 1, wherein said recommendation is a determination whether to issue a join this group recommendation.

11. The method according to claim 1, wherein said recommendation is a determination whether to issue a create a new group recommendation.

12. A computer system comprising:
one or more processors, one or more computer-readable memories and one or more computer-readable, tangible storage devices;
an analytics engine, operatively coupled to at least one of the one or more storage devices for execution by at least one of the one or more processors via at least one of the one or more memories, receiving data from at least one data source;
an identity management system, operatively coupled to at least one of the one or more storage devices for execution by at least one of the one or more processors via at least one of the one or more memories, providing data to said analytics engine;
an enterprise communities database, operatively coupled to at least one of the one or more storage devices for execution by at least one of the one or more processors via at least one of the one or more memories, providing data to said analytics engine, wherein said analytics engine issues at least one recommendation based on said data from said at least one data source, said identity management system data and said enterprise communities database data.

13. The system according to claim 12, wherein said at least one data source is unstructured data from an enterprise intranet.

14. The system according to claim 12, wherein said at least one data source is unstructured data from an extended enterprise extranet.

15. The system according to claim 12, wherein said at least one data source is unstructured data that is time generated.

16. The system according to claim 12, wherein said at least one data source is embedded meta-data from distinct data.

17. The system according to claim 12, wherein said analytics engine processes said data from said at least one data source using text analytics.

18. The system according to claim 12, wherein said analytics engine processes said data from said at least one data source using web analytics.

19. The system according to claim 12, wherein said analytics engine processes said data from said identity management communities database using identity analytics.

20. A computer program product comprising:
one or more computer-readable, tangible storage medium;
program instructions, stored on at least one of the one or more storage medium, to receive data from at least one data source and provide said data from said at least data source to an analytics engine;
program instructions, stored on at least one of the one or more storage medium, to receive data from an identity management system and provide said identity management data to said analytics engine;
program instructions, stored on at least one of the one or more storage medium, to receive data from an enterprise communities database and provide said enterprise communities database data to said analytics engine, wherein said analytics engine issues at least one recommendation based on said data from said at least one data source, said identity management system data and said enterprise communities database data.

21. The computer program product according to claim 20, wherein said recommendation is a determination whether to issue a join this group recommendation.

22. The computer program product according to claim 20, wherein said recommendation is a determination whether to issue a create a new group recommendation.
